(19) United States
(12) Patent Application Publication
(10) Pub. No.: US 2020/0060393 A1
(43) Pub. Date: Feb. 27, 2020

(54) Removable Jewelry Stability Apparatus

(71) Applicant: Pati Ann Gross, Pinellas Park, FL (US)

(72) Inventor: Pati Ann Gross, Pinellas Park, FL (US)

(21) Appl. No.: 16/106,880

(22) Filed: Aug. 21, 2018

(51) Int. Cl. A44C 15/00

(52) U.S. Cl. CPC A44C 15/003; B32B 5/18

(57) ABSTRACT

A removable apparatus prevents movement of jewelry when worn by a user. The removable apparatus has a length of material having a first surface located opposite a second surface. The length of material has an adhesive layer connected to the first surface of the length of material. The adhesive layer is configured to connect to an inner wall surface of a piece of jewelry. At least a portion of the removable apparatus is configured to contact a user when being worn by a user. The removable apparatus can have a plurality of slits or a plurality of perforations traversing the removable apparatus to circulate air flow between a user and the piece of jewelry. The removable apparatus can have a layer of moisturizer connected to the second surface of the length of material and may have a protruding structure extending from the second surface of the length of material.

### BACKGROUND OF THE INVENTION

### 1. Field of the Invention

This invention relates, generally, to a removable jewelry stability apparatus for preventing movement of jewelry when worn by a user. More particularly, it relates to a length of material having an adhesive layer, the length of material is connected to an inner wall surface of a bracelet.

### 2. Background Art

A counterweight or a counterbalance is currently known to be a weight that is used to offset the weight of another item, putting the two in balance. When a user is wearing jewelry including, but not limited to, a bracelet, a cuff bracelet, a bangle, or a wrist watch, a counterweight may be used to keep the jewelry positioned in a desired orientation. For example, a counterweight connected to the clasp of a bracelet will keep the clasp under a user's wrist when being worn by a user, thus hiding the clasp from view and orienting the stones or designs of the bracelet upwards. However, it is more desirable to maintain the positioning of jewelry when worn by a user without adding any additional bulky weight and without having to visually see the additional counterweight. A counter weight may detract from the esthetics exhibited from the piece of jewelry. Thus, there is a need for jewelry to maintain a desired position when being worn by a user that is both light weight and inconspicuous.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a removable jewelry stability apparatus which prevents movement of jewelry when worn by a user. The removable jewelry stability apparatus has a length of material having a first surface located opposite a second surface. The length of material has an adhesive layer connected to the first surface of the length of material. The adhesive layer is configured to connect to an inner wall surface of a piece of jewelry. At least a portion of the removable jewelry stability apparatus is configured to contact a user when being worn by a user. The removable jewelry stability apparatus can have a plurality of slits or a plurality of perforations traversing the length of material to circulate air flow between a user and the piece of jewelry. The removable jewelry stability apparatus can have a layer of moisturizer or scented gel connected to the second surface of the length of material and may have a protruding structure extending from the second surface of the length of material. This novel invention also includes improvements that overcome the limitations of prior art removable jewelry stability apparatuses and is now met by a new, useful, and non-obvious invention.

The novel removable jewelry stability apparatus is configured to prevent movement of jewelry when worn by a user and includes a piece of jewelry having an outer wall surface and an inner wall surface. At least a portion of the inner wall surface of the piece of jewelry is configured to contact a user when being worn by the user. The removable jewelry stability apparatus has a length of material having a first surface located opposite a second surface. The length of material has an adhesive layer connected to the first surface of the length of material. The adhesive layer of the length of material is connected to at least a portion of the inner wall surface of the piece of jewelry. At least a portion of the removable jewelry stability apparatus is configured to contact a user when being worn by the user.

In a preferred embodiment, the novel removable jewelry stability apparatus is removably connected to a piece of jewelry including, but not limited to, a bracelet, a necklace, a cuff bracelet, a bangle, a ring, or a wrist watch.

In another embodiment, the novel removable jewelry stability apparatus has a plurality of slits traversing at least a portion of the removable jewelry stability apparatus. In particular, the plurality of slits are openings that are oriented at any angle or may be oriented at a 90 degree angle so that a slit goes through both the first surface and second surface of the length of material and though the adhesive layer as well. The plurality of slits are configured to circulate air flow between a user and the piece of jewelry.

In another embodiment, the novel removable jewelry stability apparatus has a plurality of perforations located thereon. In particular, the plurality of perforations are openings that are oriented at any angle or may be oriented at a 90 degree angle so that a perforation goes through both the first surface and second surface of the length of material and though the adhesive layer as well. The plurality of perforations are configured to circulate air flow between a user and the piece of jewelry.

In yet another embodiment, the novel removable jewelry stability apparatus has a length of material being any layer of material including, but not limited to, foam, rubber, plastic, or gel.

In another embodiment, the novel removable jewelry stability apparatus can have a length of material having a layer of moisturizer connected to the second surface of the length of material. The layer of moisturizer is configured to contact a user's skin during use to moisturize the skin of a user and to minimize irritation from the use of the removable jewelry stability apparatus. It is within the scope of this invention for the moisturizer to have scented oil or a perfume.

In another embodiment, the novel removable jewelry stability apparatus can have a length of material having a layer of scented oil.

In another embodiment, the novel removable jewelry stability apparatus can have a length of material having a layer of perfume.

In an alternate embodiment, the novel removable jewelry stability apparatus has at least one protruding structure extending from the second surface of the length of material. The protruding structure is a slip resistant material and contacts a user's skin when being worn by a user. The protruding structures suspend the length of material over a user's skin to increase air flow between a user's skin and the piece of jewelry being worn. The protruding structures also help to anchor the length of material to a user's skin at select contact points to aide in the slip resistant feature of the novel removable jewelry stability apparatus. It is within the slope of this invention for the slip resistant material of the protruding structures to include, but not be limited to, foam, plastic, rubber, metal.

In a preferred embodiment, the novel removable jewelry stability apparatus has a plurality of sizes and a plurality of shapes to accommodate a variety of differing pieces of jewelry and timepieces.

In an alternate embodiment, the novel removable jewelry stability apparatus can have a metal coating located on at least a portion of the removable jewelry stability apparatus. This metal coating will help conceal the length of material. For example, if a user is wearing a gold watch, a gold colored metal coating or layer can cover the length of material of the novel removable jewelry stability apparatus so that the length of material appears to be a part of the gold watch when connected to the gold watch. Alternatively, the length of material can be tinted any color to help match the color of the length of material to the color of the piece of jewelry it will be connected to.

### BRIEF DESCRIPTION OF THE DRAWINGS

For a fuller understanding of the nature and objects of the invention, reference should be made to the following detailed description, taken in connection with the accompanying drawings, in which:

FIG. 1 is a side cut away view of the novel removable jewelry stability apparatus having an adhesive layer connected to an inner wall surface of a bracelet and having a moisturizer layer overlaying a user's skin;

FIG. 2 is an exploded perspective view of the novel removable jewelry stability apparatus having an adhesive layer configured to connect to an inner wall surface of a bracelet;

FIG. 3 is a side cut away view of the novel removable jewelry stability apparatus having a plurality of slits;

FIG. 4 is a top perspective view of the novel removable jewelry stability apparatus having a plurality of slits;

FIG. 5 is a side cut away view of the novel removable jewelry stability apparatus having a layer of scented gel and a plurality of protruding structures connected thereto;

FIG. 6 is a side cut away view of the novel removable jewelry stability apparatus having a plurality of perforations; and,

FIG. 7 is a top perspective view of the novel removable jewelry stability apparatus having a plurality of perforations.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In a general embodiment the novel removable jewelry stability apparatus is a length of material including, but not limited to, foam, plastic, rubber, or any pliable material capable of conforming to a surface of a piece of jewelry and conforming to a user. The length of material is connected to the rear surface of a piece of jewelry which would otherwise be contacting a user's skin. To keep the length of material positioned in place during use, a layer of adhesive is connected to the length of material. The adhesive layer is then connected to the rear surface of the piece of jewelry. The length of material is removable from the piece of jewelry and can be peeled off of the piece of jewelry by a user when desired. The length of material can be coated with a layer of metal to conceal the length of material so it looks like the jewelry it is connected to. The length of material can alternatively be pigmented during the manufacture of the length of material to be any desired color. The length of material may be precut to a predetermined size or shape during manufacturing. The length of material may alternatively be configured to be cut by a user to a desired size and shape.

In an alternate embodiment, the novel removable jewelry stability apparatus can have a plurality of slits or perforations to increase air circulation between a user's skin and the jewelry being worn.

In a second alternate embodiment, the novel removable jewelry stability apparatus can have a plurality of protruding structures to increase air circulation between a user's skin and the jewelry being worn. The protruding structures have a first end connected to the length of material located opposite a second end configured to contact a user's skin. The protruding structures suspend the length of material up from a user's skin to increase air flow between a user's skin and the length of material.

In a third alternate embodiment, the novel removable jewelry stability apparatus can have a layer of moisturizer configured to contact a user's skin when being worn by a user. The layer of moisturizer may be scented with oil or perfume.

### Construction of the Novel Jewelry Stability Apparatus

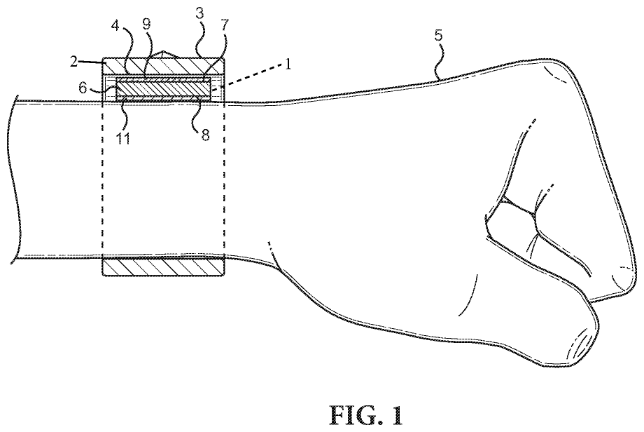

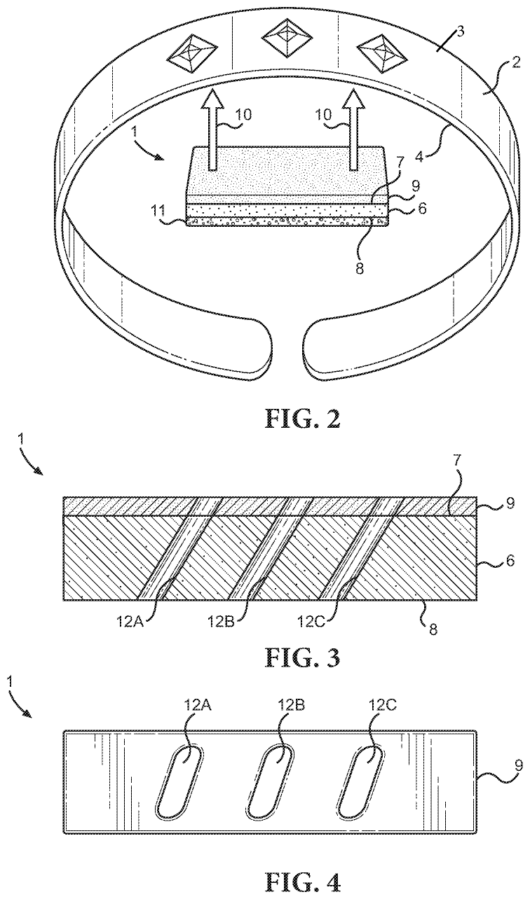

It will now be seen, referring to FIGS. 1 and 2, the novel removable jewelry stability apparatus 1 is connected to jewelry 2 being a cuff bracelet. Jewelry 2 has outer wall surface 3 located opposite inner wall surface 4. Jewelry stability apparatus 1 has length of material 6. Length of material 6 has primary surface 7 located opposite secondary surface 8. Primary surface 7 of length of material 6 has adhesive layer 9 connected thereto. Adhesive layer 9 is configured to connect to 10 (FIG. 2) inner wall surface 4 of jewelry 2. FIG. 1 illustrates adhesive layer 9 connected to inner wall surface 4 of jewelry 2.

FIGS. 1-2 depict secondary surface 8 of length of material 6 having moisturizer layer 11 connected thereto. Moisturizing layer 11 overlays the skin of a user 5 (FIG. 1) and is in contact with the skin of a user 5 (FIG. 1) when removable jewelry stability apparatus 1 is connected to jewelry 2 during use.

FIGS. 3-4 illustrate an alternate embodiment of novel removable jewelry stability apparatus 1 having a plurality of slits 12A, 12B, and 12C. FIG. 3 shows length of material 6 having primary surface 7 located opposite secondary surface 8. Primary surface 7 of length of material 6 has adhesive layer 9 (FIGS. 3-4) connected thereto. Plurality of slits 12A-12C extends the length of material 6 as well as through adhesive layer 9. Adhesive layer 9 is configured to connect to inner wall surface 4 of jewelry 2. Secondary surface 8 of length of material 6 is configured to contact a user 5 (FIG. 1) when removable jewelry stability apparatus 1 is connected to jewelry 2 (FIG. 1) during use. It is within the scope of this invention for secondary surface 8 of length of material 6 in any embodiment to have moisturizer layer 11 connected thereto. It is also within the scope of this invention for plurality of slits 12A-12C to extend through the moisturizer layer 11 (not shown).

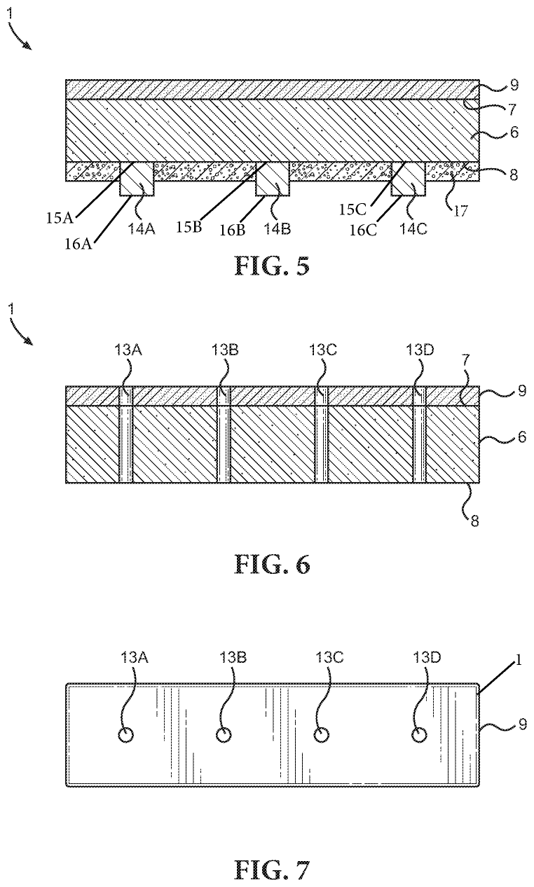

FIG. 5 illustrates jewelry stability apparatus 1 having length of material 6. Length of material 6 has primary surface 7 located opposite secondary surface 8. Primary surface 7 of length of material 6 has adhesive layer 9 connected thereto. Adhesive layer 9 is configured to connect to 10 (FIG. 2) inner wall surface 4 (FIG. 1) of jewelry 2. Protruding structures 14A-14C each have a first end 15A-15C located opposite a second end 16A-16C. First end 15A-15C of protruding structures 14A-14C is connected to secondary surface 8 of length of material 6. Second end 16A-16C of protruding structures 14A-14C is configured to contact a user's skin. Secondary surface 8 of length of material 6 can have a layer of scented gel 17 connected thereto. It is within the scope of this invention for a scented oil or perfume to be infused within the length of material in whole or in part. Protruding structures 14A-14C extend through moisturizer layer 11 (not shown) or through scented gel layer 17 (FIG. 5).

Removable jewelry stability apparatus 1 has a plurality of protruding structures 14A-14C extending from second surface 8 of length of material 6. At least one protruding structure 14A-14C is a slip resistant material. At least one protruding structure 14A-14C is configured to contact a user when being worn by a user. The protruding structures 14A-14C suspend the layer of scented gel 17 above a user's skin so that the layer of scented gel 17 does not contact a user's skin, to minimize skin irritation, to maximize air circulation, and to help dispense the scent or aroma of the layer of scented gel 17. It is within the scope of this invention for secondary surface 8 of length of material 6 in any embodiment to have scented gel layer 17 connected thereto. It is also within the scope of this invention for any embodiment of removable jewelry stability apparatus 1 to have at least one protruding structure 14.

FIGS. 6-7 show an alternate embodiment of removable jewelry stability apparatus 1 having a plurality of perforations 13A, 13B, 13C, and 13D. Referring now to FIG. 6, length of material 6 has primary surface 7 located opposite secondary surface 8. Primary surface 7 of length of material 6 has adhesive layer 9 (FIGS. 6-7) connected thereto. Plurality of perforations 13A, 13B, 13C, and 13D extends the length of material 6 as well as through adhesive layer 9 (FIGS. 6-7). Adhesive layer 9 is configured to connect to inner wall surface 4 (FIGS. 1-2) of jewelry 2 (FIGS. 1-2). Secondary surface 8 of length of material 6 is configured to contact a user 5 (FIG. 1) when removable jewelry stability apparatus 1 is connected to jewelry 2 (FIG. 1) during use. It is within the scope of this invention for secondary surface 8 of length of material 6 in this or any embodiment to have moisturizer layer 11, scented gel layer 17, protruding structure 14, or a combination of the aforementioned connected thereto.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now the invention has been described.

1. A removable jewelry stability apparatus, comprising:
a piece of jewelry, said piece of jewelry is a bracelet, said piece of jewelry having an outer wall surface, said piece of jewelry having an inner wall surface, at least a portion of said inner wall surface of said piece of jewelry is configured to contact a user when being worn by said user; and,
a removable jewelry stability apparatus having a length of material, said length of material having a primary surface located opposite a secondary surface, said length of material having an adhesive layer connected to said primary surface of said length of material, said length of material having a nonadhesive portion connected to said secondary surface of said length of material, said adhesive layer of said length of material is removably connected to said at least a portion of said inner wall surface of said piece of jewelry, thereby, orienting said nonadhesive portion to be adjacent to said inner wall surface of said piece of jewelry, at least a portion of said nonadhesive portion of said removable jewelry stability apparatus is configured to contact a user when being worn by said user, said piece of jewelry does not have a circumferential groove located within said inner wall surface of said piece of jewelry.

2-7. (canceled)

8. The removable jewelry stability apparatus of claim 1, wherein said length of material is a layer of foam.

9. The removable jewelry stability apparatus of claim 1, wherein said length of material is a layer of plastic.

10.-20. (canceled)

21. The removable jewelry stability apparatus of claim 1, wherein said length of material is tinted any color to match the color of said length of material to a color of said piece of jewelry it will be connected to.

22. A removable jewelry stability apparatus, comprising:
a piece of jewelry, said piece of jewelry is a bracelet, said piece of jewelry having an outer wall surface, said piece of jewelry having an inner wall surface, at least a portion of said inner wall surface of said piece of jewelry is configured to contact a user when being worn by said user;
a removable jewelry stability apparatus having a length of material, said length of material having a primary surface located opposite a secondary surface, said length of material having an adhesive layer connected to said primary surface of said length of material, said length of material having a nonadhesive portion connected to said secondary surface of said length of material, said adhesive layer of said length of material is removably connected to said at least a portion of said inner wall surface of said piece of jewelry, thereby, orienting said nonadhesive portion to be adjacent to said inner wall surface of said piece of jewelry, at least a portion of said nonadhesive portion of said removable jewelry stability apparatus is configured to contact a user when being worn by said user, said piece of jewelry does not have a circumferential groove located within said inner wall surface of said piece of jewelry; and,
said length of material is tinted any color to match the color of said length of material to a color of said piece of jewelry it will be connected to.
